(19) United States
(12) Patent Application Publication
(10) Pub. No.: US 2012/0102407 A1
(43) Pub. Date: Apr. 26, 2012

(54) DISPLAYING BATTERY LIFE RESULTING FROM SETTING CHANGES

(75) Inventors: Steven P. Benario, Seattle, WA (US); Ryan A. Haveson, Woodinville, WA (US); Saurabh Wagh, Kirkland, WA (US); Gaurav S. Anand, Seattle, WA (US); Ryan M. Hurst, Woodinville, WA (US)

(73) Assignee: MICROSOFT CORPORATION, Redmond, WA (US)

(21) Appl. No.: 12/911,588

(22) Filed: Oct. 25, 2010

(51) Int. Cl. G06F 3/01

(52) U.S. Cl. 715/735

(57) ABSTRACT

An indication of a remaining battery life currently available based on a current resource setting for a resource of a computing device is displayed. A user input to change the resource to a new resource setting is received, and in response to the user input an indication of the remaining battery life currently available based on the new resource setting is identified and an indication of the remaining battery life currently available based on the new resource setting is displayed. In situations where the resource is a screen of the computing device, the new resource setting can be a new screen brightness setting, and the screen brightness can be changed concurrently with displaying the remaining battery life currently available based on the new screen brightness setting.

### BACKGROUND

Battery-powered computing devices, such as mobile devices, have become very popular. Due to their being powered by a battery, these devices operate for a limited amount of time before needing the battery to be recharged. Accordingly, reducing power usage in these devices can be beneficial because it prolongs battery life. Changing settings for resources of computing devices can reduce a device's power usage, but it can be difficult for users to know exactly what result they will get in terms of power usage in their device from changing settings for a particular resource. This can make it difficult for users to make informed choices for resource settings that would result in increased battery life in their devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a scale of possible resource settings for a resource of a computing device is displayed, the scale indicating a current resource setting for the resource. An indication of a remaining battery life currently available based on the current resource setting for the resource is displayed, and a user input to change the resource to a new resource setting is received. In response to the user input, the scale is displayed indicating the new resource setting for the resource rather than the current resource setting for the resource. Also in response to the user input, the remaining battery life currently available based on the new resource setting is identified, and an indication of the remaining battery life currently available based on the new resource setting is displayed.

In accordance with one or more aspects, an indication of a remaining battery life currently available based on a current screen brightness setting for a screen of a computing device is displayed. A user input to change the screen to a new screen brightness setting is received, and in response to the user input, the remaining battery life currently available based on the new screen brightness setting is identified. Also in response to the user input, the screen is changed to the new screen brightness setting and, concurrently with the change of the screen to the new screen brightness setting, an indication of the remaining battery life currently available based on the new screen brightness setting is displayed.

### BRIEF DESCRIPTION OF THE DRAWINGS

The same numbers are used throughout the drawings to reference like features.

FIG. 1 is a block diagram illustrating an example computing device implementing the displaying battery life resulting from setting changes in accordance with one or more embodiments.

FIGS. 2A, 2B, 3A, 3B, 4A, and 4B illustrate example user interfaces displaying information regarding remaining battery life in accordance with one or more embodiments.

FIG. 5 is a flowchart illustrating an example process for a device displaying battery life resulting from setting changes in accordance with one or more embodiments.

FIG. 6 is a flowchart illustrating another example process for a device displaying battery life resulting from setting changes in accordance with one or more embodiments.

FIG. 7 illustrates an example computing device that can be configured to implement the displaying battery life resulting from setting changes in accordance with one or more embodiments.

### DETAILED DESCRIPTION

Displaying battery life resulting from setting changes is discussed herein. Various resources in a computing device have configurable settings that can affect their power consumption. A user interface allows the user to change the setting on such a resource, resulting in a change in the power consumed by that resource. The user interface displays an indication of remaining battery life based on the current setting of the resource, and after the setting is changed displays a new indication of the remaining battery life based on the new setting. This change can be made in real-time, giving the user immediate feedback regarding the change in terms of remaining battery life due to the change in resource setting.

Additionally, the resource can be a screen and the different settings can correspond to different screen intensities or brightness levels. In such situations, after the setting is changed to a new setting, the screen intensity or brightness is changed to the new setting while displaying the new indication of remaining battery life based on the new setting. This change in screen intensity or brightness can be made in real-time, giving the user immediate feedback as to the change in remaining battery life due to the change in resource setting, as well as immediate feedback as to the screen intensity or brightness associated with that particular setting and corresponding remaining battery life.

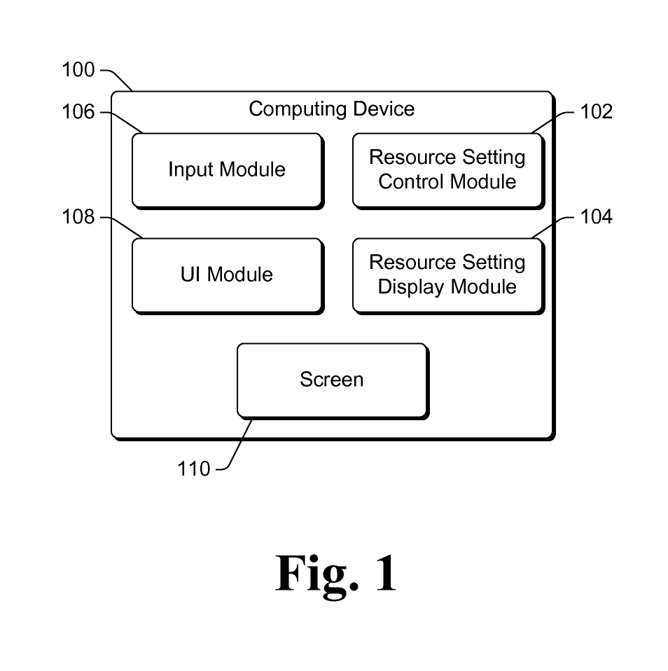

FIG. 1 is a block diagram illustrating an example computing device 100 implementing the displaying battery life resulting from setting changes in accordance with one or more embodiments. Computing device 100 can be a variety of different types of devices powered by one or more batteries. Computing device 100 is typically a mobile type of device that can operate on battery power, such as a netbook or laptop computer, a notepad or tablet computer, a mobile station, an entertainment appliance, a cellular or other wireless phone, a game console, an audio and/or video playback device, and so forth. However, computing device 100 can be other types of devices, such as a desktop computer, a set-top box communicatively coupled to a display device, a television, a plug-in game console, an automotive computer, and so forth.

Computing device 100 includes a resource setting control module 102, a resource setting display module 104, an input module 106, a user interface (UI) module 108, and a screen 110. Each of modules 102, 104, 106, and 108 can be implemented in software, firmware, hardware, or combinations thereof. When implemented in software or firmware, a module includes one or more instructions that are executed by one or more processors or controllers of computing device 100.

Screen 110 is a display component of computing device 100. Screen 110 can be implemented in a variety of different manners, such as using liquid crystal display (LCD) technology, plasma screen technology, image projection technology, and so forth. Alternatively, rather than including screen 110, computing device 100 can generate one or more signals that are output to other display devices which include screen 110.

Input module 106 receives user inputs from a user of computing device 100. User inputs can be provided by a user in a variety of different manners, such as by pressing one or more keys of a keypad or keyboard of device 100, by pressing a particular portion of a touchpad or touchscreen of device 100, by making a particular motion or gesture on a touchpad or touchscreen of device 100, and so forth. The user input can also be provided in other manners, such as via audible inputs, particular motions (e.g., moving fingers, hands, or other parts of the body in a particular manner) captured by an image capture component of device 100, other physical feedback input to the device (e.g., tapping any portion of device 100 or another action that can be recognized by a motion detection component of device 100, such as shaking device 100, rotating device 100, etc.), and so forth.

UI module 108 generates, manages, and/or outputs a user interface for display on screen 110. The user interface can also optionally be output to, in addition to or instead of screen 110, one or more other screens. This user interface displays various information on screen 110, and user inputs in response to the displayed information can be received by input module 106 as discussed above. UI module 108 can display, for example, controls with which the user of computing device 100 can interact (providing an input via input module 106), remaining battery life information provided by resource setting display module 104 as discussed in more detail below, and so forth. Although UI module 108 is discussed herein as displaying information, it should be noted that information can be presented in other manners (e.g., audio presentation).

Computing device 100 can include and/or be coupled to one or more resources having different resource settings. For example, screen 110 can be a resource of computing device, and can be implemented as part of computing device 100 or alternatively be coupled to computing device 100. Each resource typically consumes different amounts of power at different resource settings for that resource. These resource settings typically range from a highest or maximum setting to a lowest or minimum setting, and the user can select the resource setting that he or she desires.

Depending on the particular resource and the manner in which resource settings for the resource are expressed, higher resource settings can result in greater power consumption than lower settings, or alternatively lower resource settings can result in greater power consumption than higher settings. For example, assume a resource is a screen and the resource settings correspond to a refresh rate for the screen. If the resource settings are expressed in terms of refresh rate, then a higher setting results in a higher refresh rate than a lower setting, and can also result in greater power consumption than the lower setting. Alternatively, the refresh rate can be expressed in terms of time between screen refreshes, in which case a lower setting results in a higher refresh rate (less time between screen refreshes) and can also result in greater power consumption than a higher setting.

A variety of different resources that support different settings can be resources of computing device 100. For example, a resource can be a screen, a processor, a wireless transmitter, a speaker, and so forth. Additionally, a resource can have different types of resource settings. For example, a screen can have resource settings for brightness levels (or intensities) for the screen, refresh rates for the screen, and so forth. It should be noted that these are examples of resources, and that other resources that support different settings can also be resources of computing device 100.

A screen can have different resource settings that correspond to different brightness levels (or intensities) for the screen. A resource setting resulting in a more intense or brighter screen than another resource setting also typically results in (but need not result in) greater power consumption than the other setting. The particular brightness settings that a screen has can vary by screen, being based at least in part on the particular characteristics and capabilities of each particular screen and hardware components controlling that particular screen.

A screen can also have other types of resource settings, such as different resource settings that correspond to a refresh rate for the screen. A resource setting resulting in a higher refresh rate than another resource setting also typically results in (but need not result in) greater power consumption than the other setting. The particular refresh rates that a screen has can vary by screen, being based at least in part on the particular characteristics and capabilities of each particular screen and hardware components controlling that particular screen.

A processor has different resource settings that correspond to different performance levels for the processor. Different processor performance levels can be obtained in a variety of different manners, such as changing the speed (e.g., clock frequency) of the processor, changing the number of processor cores or processors that are used by the device, and so forth. A resource setting resulting in greater processing power (e.g., the ability to execute a larger number of instructions per second) for the device than another resource setting also typically results in (but need not result in) greater power consumption than the other resource setting. The particular performance level settings that a processor has can vary by processor, being based at least in part on the particular characteristics and capabilities of each particular processor.

A wireless transmitter has different resource settings that correspond to different transmission power strengths for the device. A resource setting resulting in a greater transmission power strength and thus greater wireless range for the device than another resource setting also typically results in (but need not result in) greater power consumption than the other resource setting. The particular transmission power strength settings that a wireless transmitter has can vary by wireless transmitter, being based at least in part on the particular characteristics and capabilities of each particular wireless transmitter.

In one or more embodiments, resource setting display module 104 displays, via UI module 108, an indication of a scale of possible resource settings for a resource as well as a current resource setting for the resource. For example, the scale can include a line or other geometric figure that ranges from a higher setting value (e.g., a maximum setting value) for the resource at one end to a lower setting value (e.g., a minimum setting value) for the resource at the other end, and the current resource setting being indicated on the scale somewhere at or between the two ends. Which end of the scale corresponds to a higher power consumption can vary by implementation.

Additionally, resource setting display module 104 displays an indication of a remaining battery life of computing device 100 if the resource continues to operate at its current resource setting (continues to operate at the status quo). This indication can be displayed in different manners, such as in terms of hours and/or minutes of remaining battery life, an indication of how many more movies computing device 100 can play back at its current resource setting, an indication of how many more songs computing device 100 can play back at its current resource setting, and so forth.

Resource setting control module 102 manages configuring the resources of computing device 100 with the appropriate settings. Resources can have an initial or default setting, which can be changed by a user. In response to a user input, received via input module 106, to change the setting of a particular resource, resource setting control module 102 communicates a request or command to the resource to change the setting of that resource to the setting indicated by the user input. This request or command can be communicated to the resource itself, or to a component or module associated with or controlling the resource.

Additionally, in response to the user input to change the setting of a particular resource, resource setting display module 104 identifies a remaining battery life of computing device 100 that is currently available if the resource continues to operate at the new resource setting. Resource setting display module 104 displays an indication of the new resource setting (rather than the previous resource setting), and also displays the remaining battery life of computing device 100 that is currently available if the resource continues to operate at the new resource setting. Resource setting display module 104 provides the user with real-time feedback regarding the result (in terms of remaining battery life) of changing the resource setting of a particular resource. The real-time feedback refers to the feedback being displayed a short time (e.g., less than a second) after the user input is received, so that the user perceives very little (if any) time lag between the user input and the change in remaining battery life resulting from that user input. For example, the user gets an immediate feedback indicating how many hours and/or minutes of remaining battery life is available at the new resource setting.

It should be noted that the discussions herein regarding a remaining battery life can refer to an estimate of remaining battery life or the actual remaining battery life. The estimate of remaining battery life can be identified in different manners as discussed in more detail below. Although the actual remaining battery life can be determined, the displaying battery life resulting from setting changes need not use the actual remaining battery life. Rather, identifying an estimate of the remaining battery life in response to resource setting changes still provides feedback to the user (e.g., a number of hours and/or minutes) of the remaining battery life at different resource settings, and thus an indication of how much additional battery life the user can gain by selecting particular resource settings.

It should also be noted that resource setting control module 102 can provide, in response to a user input, real-time change to the setting for the resource. The real-time change refers to the change being made a short time (e.g., less than a second) after the user input is received, so that the user perceives very little (if any) time lag between the user input and the change to the resource. For example, if the resource is a screen and the different settings correspond to different screen brightness levels, then resource setting control module 102 provides real-time changes to the screen brightness setting, allowing the user to readily see what the result is (in terms of screen brightness that the user is perceiving) of changing the screen brightness setting. The screen brightness setting is changed quickly (e.g., less than a second) after the user input is received so that the user perceives very little (if any) time lag between the user input and the change in screen brightness.

However, it should be noted that resource setting control module 102 need not provide real-time change to the resource in response to a user input. Rather, the change to the resource can be performed some amount of time after the user input is made, or after the user has chosen to accept the new resource setting (e.g., by selecting a displayed “accept” button or option, by not changing the new resource setting for at least a threshold amount of time after entering the new resource setting, and so forth). Resource setting display module 104, however, still provides the user with real-time feedback regarding the result (in terms of remaining battery life) of changing the resource setting of a particular resource. For example, if the resource is a processor, then resource setting display module 104 provides the user with real-time feedback regarding the result (in terms of remaining battery life) of changing the processor setting, even though resource setting control module 102 may provide the new resource setting to the processor only after the user has chosen to accept the new resource setting.

Additionally, in situations in which the resource is a screen and the different settings correspond to different screen brightness levels, in response to a new setting being received the screen brightness is changed to the new setting concurrently with displaying the new indication of remaining battery life based on the new setting. Changing the screen brightness setting and displaying the new indication of remaining battery life concurrently refers to both the change in screen brightness setting and the new indication of remaining battery life being displayed at approximately the same time (e.g., within one second of each other), so that there is very little (if any) difference perceived by the user between the time when the screen brightness level is changed and the indication of the remaining battery life is displayed. This allows, for example, the user to readily see what the result is (in terms of both screen brightness that the user is perceiving and the remaining battery life) of changing the screen brightness setting.

In FIG. 1, resource setting control module 102 and resource setting display module 104 are implemented as part of computing device 100. The resource for which settings are changed can be included as part of computing device 100, such as a screen or processor that is included as part of computing device 100. Alternatively, the resource for which settings are changed can be separate from computing device 100, such as a screen that is part of a display device separate from computing device 100. In situations where the resource is in a device separate from computing device 100, the battery for which remaining battery life is displayed is the battery that powers the device that includes the resource.

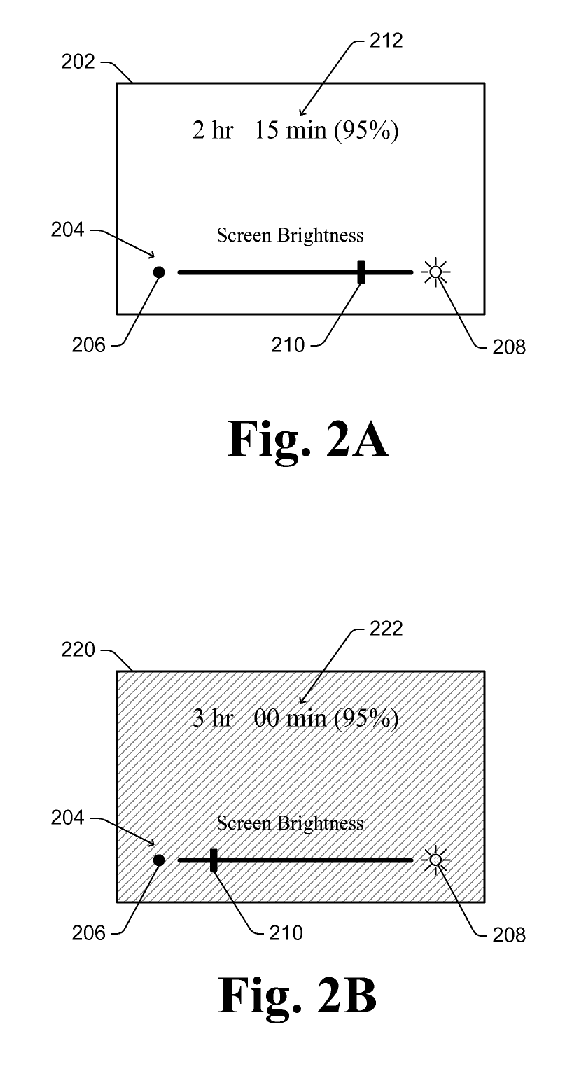

FIGS. 2A and 2B illustrate example user interfaces displaying information regarding remaining battery life in accordance with one or more embodiments. FIGS. 2A and 2B illustrate information for a resource that is a screen of a computing device. FIG. 2A illustrates a window 202 including a scale 204 for screen brightness ranging from a lower brightness level end to a higher brightness level end. The lower brightness level end of scale 204 is illustrated by an icon 206 that is a closed circle, while the higher brightness level end of scale 204 is illustrated by an icon 208 that is an open circle surrounded by lines protruding outward from the circle.

A current resource setting for the screen brightness is indicated on scale 204 by icon 210, which is illustrated as a block. The user can change the location of icon 210 on scale 204 by providing, via input module 106 of FIG. 1, a variety of different user inputs. The user changing the location of icon 210 on scale 204 is a user input to change the screen brightness setting.

Window 202 also includes an indication 212 of remaining battery life currently available based on the current resource setting (the current screen brightness setting) for the screen (which can be an estimate of remaining battery life as discussed above). As illustrated in FIG. 2A, at the current screen brightness setting the remaining battery life available for the device is 2 hours and 15 minutes. Indication 212 also includes an identification of an amount of the overall capacity of the battery that currently remains, which is 95% in the example of FIG. 2A.

FIG. 2B illustrates a window 220 similar to window 202 of FIG. 2A. However, in window 220 the location of icon 210 has been moved closer to the lower brightness level end of scale 204. The screen brightness setting illustrated in window 220 is less bright than the screen brightness setting illustrated in window 202, and thus power consumption for the screen brightness setting illustrated in window 220 is less than the power consumption for the screen brightness setting illustrated in window 202. Accordingly, window 220 includes an indication 222 of remaining battery life (which can be an estimate of remaining battery life as discussed above) currently available based on the current resource setting (the current screen brightness setting) for the screen that is greater than the remaining battery life illustrated in window 202. As illustrated in FIG. 2B, at the current screen brightness setting the remaining battery life available for the device is 3 hours and 00 minutes, and the overall capacity of the battery remains 95%.

Additionally, as the screen is less bright for the screen brightness setting illustrated in FIG. 2B than for the screen brightness setting illustrated in FIG. 2A, and the windows 202 and 220 are displayed on that screen, window 220 is displayed as less bright than window 202. Window 220 is illustrated with cross-hatching to represent window 220 being less bright than window 202.

Thus, as can be seen in FIGS. 2A and 2B, if the user changes the resource setting (the screen brightness setting), the user is provided with real-time feedback as to the change in remaining battery life resulting from the change in resource setting. For example, if the user changes the screen brightness setting from the setting in window 202 to the setting in window 220, the user is given real-time feedback that the change in screen brightness setting results in an additional 45 minutes of remaining battery life. Furthermore, the screen brightness is also changed in real-time, allowing the user to see exactly the screen brightness he or she will have for the changed screen brightness setting. Thus, the user can change the screen brightness setting and readily see the result of the change both in terms of screen brightness and the remaining battery life.

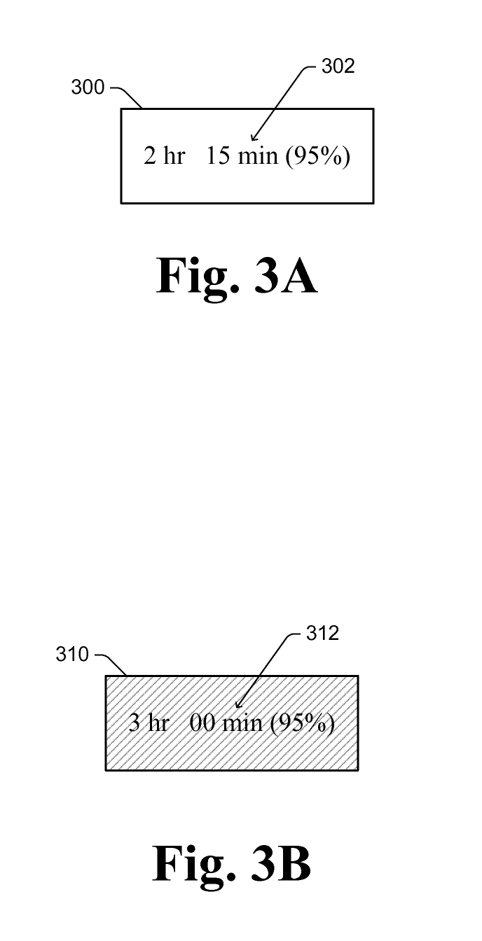

FIGS. 3A and 3B illustrate additional example user interfaces displaying information regarding remaining battery life in accordance with one or more embodiments. FIGS. 3A and 3B illustrate information for a resource that is a screen of a computing device. FIG. 3A illustrates a window 300 including an indication 302 of remaining battery life currently available based on the current resource setting (the current screen brightness setting) for the screen at the time window 300 is displayed (which can be an estimate of remaining battery life as discussed above). FIG. 3B illustrates a window 310 including an indication 312 of remaining battery life (which can be an estimate of remaining battery life as discussed above) currently available based on the current resource setting (the current screen brightness setting) for the screen at the time window 310 is displayed. The current screen brightness setting in FIG. 3A is higher than the current screen brightness setting in FIG. 3B, thus the remaining battery life currently available based on the current screen brightness setting for the screen is greater in indication 312 than in indication 302. Additionally, analogous to FIG. 2B discussed above, window 310 is illustrated with cross-hatching to represent that window 310 is less bright than window 300 due to the lower screen brightness setting in FIG. 3B than in FIG. 3A.

FIGS. 3A and 3B illustrate windows 300 and 310 that are similar to windows 202 and 220, respectively, of FIGS. 2A and 2B. Windows 300 and 302 provide real-time feedback as to the change in remaining battery life resulting from the change in resource setting, and also provide real-time feedback in terms of screen brightness, allowing the user to see exactly the screen brightness and remaining battery life he or she will have resulting from changing the screen brightness setting. However, windows 300 and 310 do not include a scale indicating a range of resource settings (e.g., a scale 204 of FIGS. 2A and 2B).

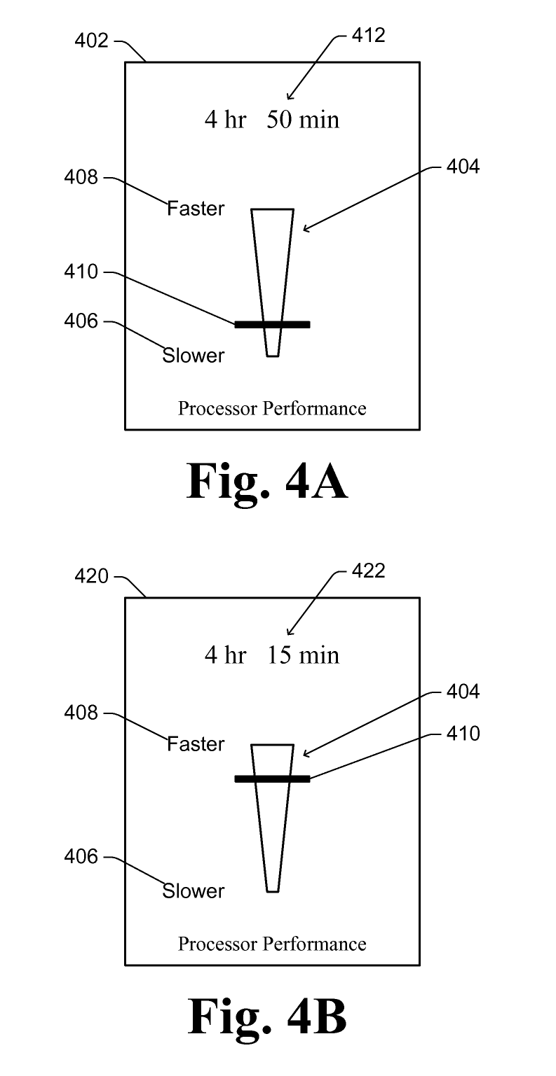

FIGS. 4A and 4B illustrate additional example user interfaces displaying information regarding remaining battery life in accordance with one or more embodiments. FIGS. 4A and 4B illustrate information for a resource that is a processor of a computing device. FIG. 4A illustrates a window 402 including a scale 404 for processor performance ranging from slower performance to faster performance. The slower performance end of scale 404 is illustrated by a word (“slower”) 406, while the faster performance end of scale 404 is illustrated by a word (“faster”) 408.

A current resource setting for the processor performance is indicated on scale 404 by icon 410, which is illustrated as a block. The user can change the location of icon 410 on scale 404 by providing, via input module 106 of FIG. 1, a variety of different user inputs. The user changing the location of icon 410 on scale 404 is a user input to change the processor performance setting.

Window 402 also includes an indication 412 of remaining battery life currently available based on the current resource setting (the current processor performance setting) for the processor (which can be an estimate of remaining battery life as discussed above). As illustrated in FIG. 4A, at the current processor performance setting the remaining battery life available for the device is 4 hours and 50 minutes.

FIG. 4B illustrates a window 420 similar to window 402 of FIG. 4A. However, in window 420 the location of icon 410 has been moved closer to the faster performance end of scale 404. The processor performance setting illustrated in window 420 is a faster processor performance setting than the processor performance setting illustrated in window 402, and thus power consumption for the processor performance setting illustrated in window 420 is greater than the power consumption for the processor performance setting illustrated in window 402. Accordingly, window 420 includes an indication 422 of remaining battery life (which can be an estimate of remaining battery life as discussed above) currently available based on the current resource setting (the current processor performance setting) for the processor that is less than the remaining battery life illustrated in window 402. As illustrated in FIG. 4B, at the current processor performance setting the remaining battery life available for the device is 4 hours and 15 minutes.

Thus, as can be seen in FIGS. 4A and 4B, if the user changes the resource setting (the processor performance setting), the user is provided with real-time feedback as to the change in remaining battery life resulting from the change in resource setting. For example, if the user changes the processor performance setting from the setting in window 402 to the setting in window 420, the user is given real-time feedback that the change in processor performance setting results in 35 fewer minutes of remaining battery life.

It should be noted that the examples illustrated in FIGS. 2A, 2B, 3A, 3B, 4A, and 4B are examples, and that various modifications to the user interfaces displayed in accordance with the displaying battery life resulting from setting changes discussed herein can be made. For example, the user interfaces can include images or animations that change as the resource setting is changed, such as a battery getting larger (to indicate greater battery life) or smaller (to indicate less battery life), a radio antenna surrounded by a circle that gets bigger (to indicate a larger transmitter range) or smaller (to indicate a smaller transmitter range), and so forth. Such images animations can be included in addition to, or alternatively in place of, the hours and/or minutes of remaining battery life. By way of another example, the user interfaces can include scales and icons for multiple different resources concurrently, allowing the user to change resource settings for different resources and see the remaining battery life resulting from the various changes. In situations in which scales and icons for multiple different resources are displayed concurrently, a single remaining battery life indication is displayed. A user input to change a setting of any one or more of the multiple different resources results in a change in the single remaining battery life indication being displayed.

Returning to FIG. 1, in one or more embodiments resource setting display module 104 identifies the remaining battery life for a particular resource setting. As discussed above, this remaining battery life can be an estimation of the remaining battery life and is typically close to (but need not be exactly) the actual remaining battery life. This identification can be made in a variety of different manners. Different techniques for making this identification are discussed herein, however, it is to be appreciated that these are examples and other techniques can alternatively be used. Resource setting display module 104 can obtain (e.g., from the battery or batteries of computing device 100) an indication of an amount of charge remaining in the battery (or batteries). This information can be obtained by module 104 at virtually any time, allowing module 104 to determine an amount of charge remaining in the battery (or batteries) at virtually any time.

In one or more embodiments, the battery or batteries (or another component or module of the computing device) also provides an indication of a rate at which power is being drawn from the battery (or batteries). Module 104 can obtain (from the battery (or batteries) or other component or module) an indication of how much power is being drawn from the battery (or batteries) when the resource is at a particular resource setting, and readily identify an estimate of the remaining battery life based on that particular resource setting. For example, if the battery (or batteries) indicates an amount of charge remaining of 200 watts and that at the current resource setting the computing device is using 50 watt hours, then setting display module 104 can readily identify that the estimated remaining battery life is approximately 4 hours (200÷50=4).

In one or more other embodiments, a component or module of computing device 100 (e.g., module 104) runs a series of tests on computing device 100 to determine the power consumption of particular resources at different resource settings. This component or module sets the resource to a particular setting, determines how much power is being drawn from the battery or batteries given that particular setting, and records the amount of power being drawn from the battery or batteries at that particular setting. This determination and recording can be repeated for multiple different settings. In one or more embodiments, the determination and recording are repeated for each of the different possible resource settings. Alternatively, the determination and recording can be repeated for two or more different resource settings and the amount of power being drawn from the battery or batteries at other resource settings can be determined based on the recorded amounts of power (e.g., using interpolation and/or extrapolation). The recorded amounts of power being drawn from the battery or batteries at the particular settings can be maintained and subsequently used to identify an estimate of the remaining battery life given a particular resource setting. Given the amount of charge remaining in the battery or batteries (e.g., as provided by the battery or batteries) and the recorded amounts of power being drawn from the battery at different resource settings, module 104 can readily identify an estimate of the remaining battery life for computing device 100 given the remaining watt hours reported from the battery and an arbitrary setting for the resource.

In one or more other embodiments, resource setting display module 104 is configured with, or obtains from another component or module (of computing device 100 or alternatively another device), an indication of an estimated amount of power being drawn from the battery or batteries at particular resource settings. These indications can be identified, for example, by analyzing the amount of power being drawn from the battery or batteries of similar computing devices (e.g., devices having similar (or the same) types of screens and/or screen sizes, devices having similar (or the same) types of wireless transmitters, devices having similar (or the same) types of processors, and so forth). These indications can be identified in other manners as well, such as based on estimations from the developer or designer of resource setting display module 104 or from other sources. Regardless of the manner in which the indications of estimated amounts of power being drawn at particular resource settings are generated, given the amount of charge remaining in the battery or batteries (as provided by the battery or batteries) and the indications of estimated amounts of power being drawn from the battery or batteries at particular resource settings, module 104 can readily identify an estimate of the remaining battery life when the resource is at a particular setting.

Alternatively, the identification of the remaining battery life for a particular resource setting can be made in other manners. For example, resource setting display module 104 can be configured with, or obtain from another module or device, a number of minutes of change in remaining battery life resulting from changing a resource setting one setting value or between two particular setting values. Resource setting display module 104 can then add or subtract that number of minutes in response to a change in the resource setting. E.g., the number of minutes of change in remaining battery life can be 5 minutes, so resource setting display module 104 can identify the remaining battery life by adding 5 minutes to the previous remaining battery life (e.g., if the resource setting is changed to a higher setting value).

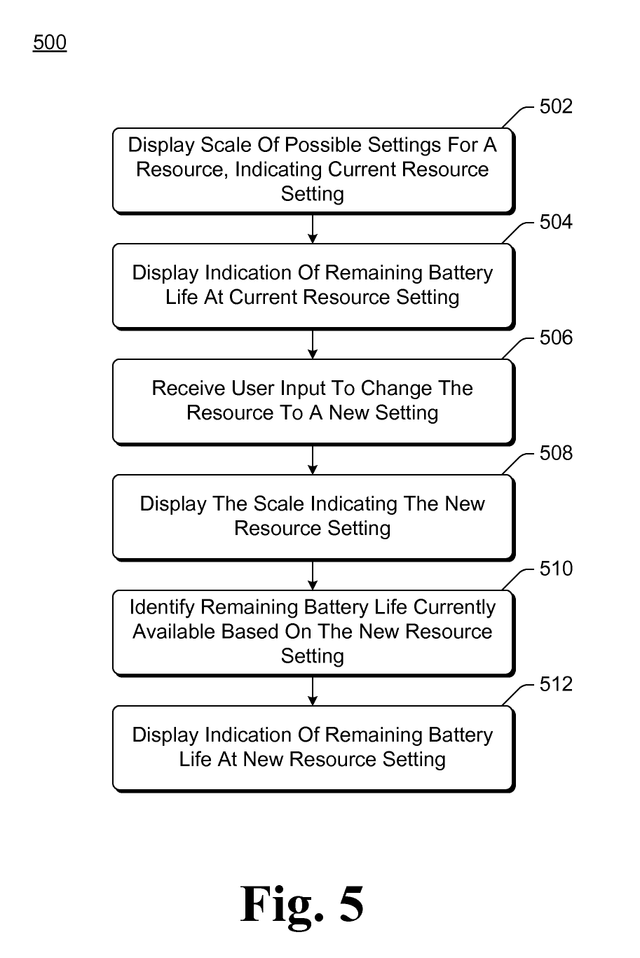

FIG. 5 is a flowchart illustrating an example process 500 for a device displaying battery life resulting from setting changes in accordance with one or more embodiments. Process 500 is carried out by a device, such as device 100 of FIG. 1, and can be implemented in software, firmware, hardware, or combinations thereof. Process 500 is shown as a set of acts and is not limited to the order shown for performing the operations of the various acts. Process 500 is an example process for displaying battery life resulting from setting changes; additional discussions of displaying battery life resulting from setting changes are included herein with reference to different figures.

In process 500, a scale of possible settings for a resource, as well as a current resource setting for that resource, is displayed (act 502). This scale can be displayed in a variety of different manners as discussed above.

An indication of a remaining battery life currently available while the resource is at the current resource setting is displayed (act 504). This indication can be, for example, an indication of a number of hours and/or minutes of battery life remaining when the resource is at the current resource setting.

A user input to change the resource to a new setting is received (act 506). This user input can be received in a variety of different manners as discussed above.

In response to the user input to change the resource to a new setting, the scale indicating the possible settings for the resource as well as the new setting for that resource is displayed (act 508).

Additionally, in response to the user input to change the resource to a new setting a remaining battery life currently available while the resource is at the new resource setting is identified (act 510). This identification can be made in a variety of different manners, and can be an estimate of the remaining battery life, as discussed above.

Also in response to the user input to change the resource to a new setting, an indication of the remaining battery life currently available while the resource is at the new resource setting is displayed (act 512). This indication can be, for example, an indication of a number of hours and/or minutes of battery life remaining when the resource is at the new resource setting.

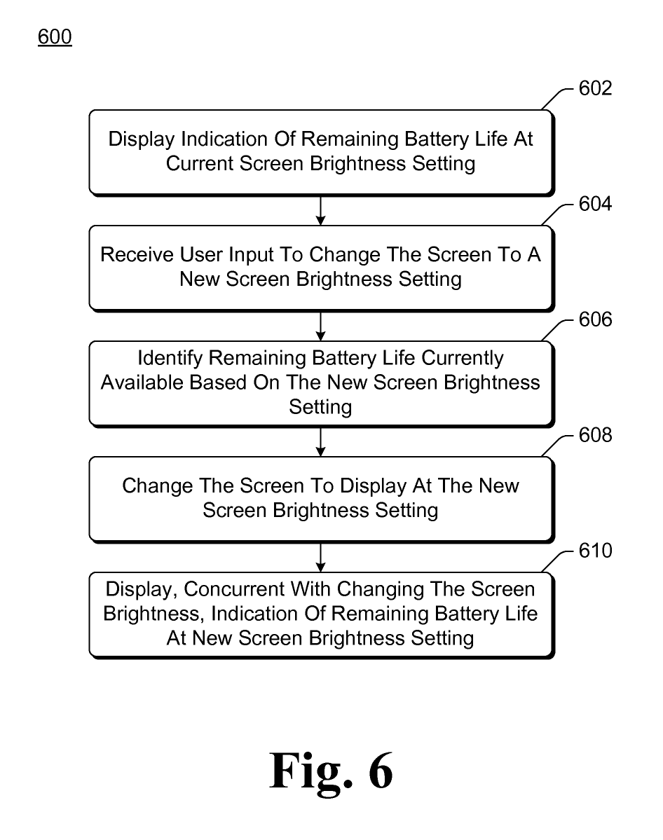

FIG. 6 is a flowchart illustrating another example process 600 for a device displaying battery life resulting from setting changes in accordance with one or more embodiments. Process 600 is carried out by a device, such as device 100 of FIG. 1, and can be implemented in software, firmware, hardware, or combinations thereof. Process 600 is shown as a set of acts and is not limited to the order shown for performing the operations of the various acts. Process 600 is an example process for displaying battery life resulting from setting changes; additional discussions of displaying battery life resulting from setting changes are included herein with reference to different figures.

In process 600, an indication of a remaining battery life currently available while a screen is at a current screen brightness setting is displayed (act 602). This indication can be, for example, an indication of a number of hours and/or minutes of battery life remaining when the screen is at the current screen brightness setting.

A user input to change the screen to a new screen brightness setting is received (act 604). This user input can be received in a variety of different manners as discussed above.

In response to the user input to change the screen to a new screen brightness setting, a remaining battery life currently available while the screen is at the new screen brightness setting is identified (act 606). This identification can be made in a variety of different manners, and can be an estimate of the remaining battery life, as discussed above.

Also in response to the user input to change the resource to a new setting, the screen is changed to display at the new screen brightness setting (act 608). This typically results in the screen being displayed brighter or darker than when the screen was being displayed at the previous screen brightness setting (e.g., in act 602).

Additionally, an indication of the remaining battery life currently available while the screen is at the new screen brightness setting is displayed (act 610). This indication can be, for example, an indication of a number of hours and/or minutes of battery life remaining when the resource is at the new screen brightness setting. The indication in act 610 is displayed concurrently with the change of the screen brightness in act 608, providing the user with an indication of the amount of battery life remaining, as well as the screen brightness, for the new screen brightness setting.

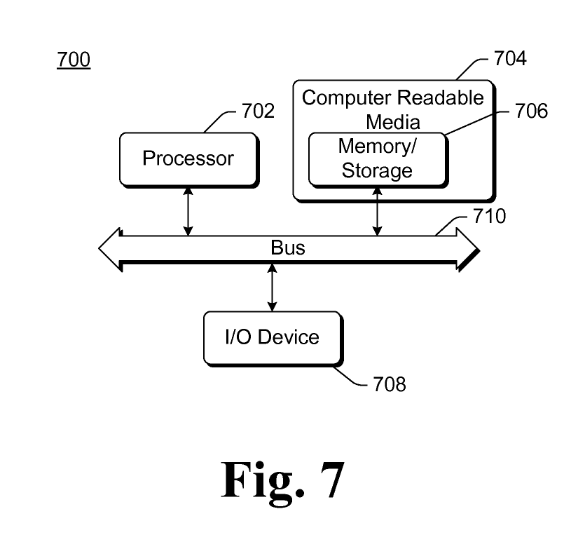

FIG. 7 illustrates an example computing device 700 that can be configured to implement the displaying battery life resulting from setting changes in accordance with one or more embodiments. Computing device 700 can be, for example, computing device 100 of FIG. 1.

Computing device 700 includes one or more processors or processing units 702, one or more computer readable media 704 which can include one or more memory and/or storage components 706, one or more input/output (I/O) devices 708, and a bus 710 that allows the various components and devices to communicate with one another. Computer readable media 704 and/or one or more I/O devices 708 can be included as part of, or alternatively may be coupled to, computing device 700. Bus 710 represents one or more of several types of bus structures, including a memory bus or memory controller, a peripheral bus, an accelerated graphics port, a processor or local bus, and so forth using a variety of different bus architectures. Bus 710 can include wired and/or wireless buses. Computing device 700 is powered, at least in part, by one or more batteries.

Memory/storage component 706 represents one or more computer storage media. Component 706 can include volatile media (such as random access memory (RAM)) and/or nonvolatile media (such as read only memory (ROM), Flash memory, optical disks, magnetic disks, and so forth). Component 706 can include fixed media (e.g., RAM, ROM, a fixed hard drive, etc.) as well as removable media (e.g., a Flash memory drive, a removable hard drive, an optical disk, and so forth).

The techniques discussed herein can be implemented in software, with instructions being executed by one or more processing units 702. The software can be implemented as an application or part of an operating system or other application. It is to be appreciated that different instructions can be stored in different components of computing device 700, such as in a processing unit 702, in various cache memories of a processing unit 702, in other cache memories of device 700 (not shown), on other computer readable media, and so forth. Additionally, it is to be appreciated that the location where instructions are stored in computing device 700 can change over time.

One or more input/output devices 708 allow a user to enter commands and information to computing device 700, and also allows information to be presented or communicated to the user and/or other components or devices. Examples of input devices include a keyboard, a cursor control device (e.g., a mouse), a microphone, a scanner, and so forth. Examples of output devices include a screen or other display device (e.g., a monitor or projector), speakers, a printer, a network card, a wireless transmitter, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embody computer readable instructions, data structures, program modules, or other data in a modulated data signal, such as carrier wave or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media. Combinations of any of the above are also included within the scope of computer readable media.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable memory devices, further description of which may be found with reference to FIG. 7. The features of the displaying battery life resulting from setting changes techniques described herein are platform-independent, meaning that the techniques can be implemented on a variety of commercial computing platforms having a variety of processors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a computing device, the method comprising:
displaying a scale of possible resource settings for a resource of the computing device, the scale indicating a current resource setting for the resource;
displaying an indication of a remaining battery life currently available based on the current resource setting for the resource;
receiving a user input to change the resource to a new resource setting;
displaying, in response to the user input, the scale indicating the new resource setting for the resource rather than the current resource setting for the resource;
identifying, in response to the user input, the remaining battery life currently available based on the new resource setting; and
displaying, in response to the user input, an indication of the remaining battery life currently available based on the new resource setting.

2. A method as recited in claim 1, wherein the resource comprises a screen of the computing device, and the possible resource settings comprise screen brightness settings.

3. A method as recited in claim 2, wherein the new resource setting comprises a new screen brightness setting, the method further comprising displaying the indication of the remaining battery life currently available based on the new screen brightness setting concurrently with changing, in response to the user input, the screen to the new screen brightness setting.

4. A method as recited in claim 2, wherein the screen is included in a display device separate from the computing device.

5. A method as recited in claim 1, wherein the resource comprises a processor of the computing device, and the possible resource settings comprise processor performance settings.

6. A method as recited in claim 1, wherein the resource comprises a wireless transmitter of the computing device, and the possible resource settings comprise transmission power strengths.

7. A method as recited in claim 1, wherein the indication of the remaining battery life is displayed in one or both of hours and minutes.

8. A method as recited in claim 1, further comprising changing, in response to the user input, the resource to operate at the new resource setting.

9. A method as recited in claim 1, the displaying the indication of the remaining battery life currently available based on the new resource setting comprising displaying the indication of the remaining battery life currently available based on the new resource setting in real-time in response to the user input.

10. A method as recited in claim 9, further comprising changing, in real-time in response to the user input, the resource to operate at the new resource setting.

11. A method as recited in claim 1, further comprising:
displaying, concurrently with displaying the scale of possible resource settings for the resource of the computing device, an additional scale of possible resource settings for an additional resource of the computing device, the additional scale indicating a current resource setting for the additional resource;
receiving a user input to change the additional resource to a new resource setting;
displaying, in response to the user input to change the additional resource to the new resource setting, the additional scale indicating the new resource setting for the additional resource rather than the current resource setting for the additional resource;
identifying, in response to the user input to change the additional resource to the new resource setting, the remaining battery life currently available based on the new resource setting of the additional resource; and
displaying, in response to the user input to change the additional resource to the new resource setting, an indication of the remaining battery life currently available based on the new resource setting of the additional resource.

12. A method as recited in claim 1, further comprising:
receiving, after displaying the scale indicating the new resource setting and displaying the indication of the remaining battery life currently available based on the new resource setting, an additional user input to change the resource to an additional new resource setting;
displaying, in response to the additional user input, the scale indicating the additional new resource setting for the resource rather than the new resource setting for the resource;
identifying, in response to the additional user input, the remaining battery life currently available based on the additional new resource setting; and
displaying, in response to the additional user input, an indication of the remaining battery life currently available based on the additional new resource setting.

13. One or more computer storage media having stored thereon multiple instructions that, when executed by one or more processors of a computing device, cause the one or more processors to:
display, based on a current screen brightness setting for a screen of the computing device, an indication of a remaining battery life currently available based on the current screen brightness setting;
receive a user input to change the screen to a new screen brightness setting;
identify, in response to the user input, the remaining battery life currently available based on the new screen brightness setting;
change, in response to the user input, the screen to the new screen brightness setting; and
display, concurrently with the change of the screen to the new screen brightness setting, an indication of the remaining battery life currently available based on the new screen brightness setting.

14. One or more computer storage media as recited in claim 13, wherein the screen is included as part of the computing device.

15. One or more computer storage media as recited in claim 13, wherein the indication of the remaining battery life is displayed in one or both of hours and minutes.

16. One or more computer storage media as recited in claim 13, wherein the multiple instructions further cause the one or more processors to display a scale of possible screen brightness settings, including an icon indicating the new screen brightness setting.

17. One or more computer storage media as recited in claim 13, wherein to change the screen to the new screen brightness setting is to change the screen to the new screen brightness setting in real-time in response to the user input, and wherein to display the indication of the remaining battery life currently available based on the new screen brightness setting is to display the indication of the remaining battery life currently available based on the new screen brightness setting in real-time in response to the user input.

18. One or more computer storage media as recited in claim 13, wherein the multiple instructions further cause the one or more processors to:
display a scale of possible resource settings for an additional resource of the computing device, the scale indicating a current resource setting for the additional resource;
receive a user input to change the additional resource to a new resource setting;
display, in response to the user input to change the additional resource to the new resource setting, the scale indicating the new resource setting for the additional resource rather than the current resource setting for the additional resource;
identify, in response to the user input to change the additional resource to the new resource setting, the remaining battery life currently available based on the new resource setting of the additional resource; and
display, in response to the user input to change the additional resource to the new resource setting, an indication of the remaining battery life currently available based on the new resource setting of the additional resource.

19. One or more computer storage media as recited in claim 13, wherein the multiple instructions further cause the one or more processors to:
receive an additional user input to change the screen to an additional new screen brightness setting;
identify, in response to the additional user input, the remaining battery life currently available based on the additional new screen brightness setting;
change, in response to the additional user input, the screen to the additional new screen brightness setting; and
display, concurrently with the change of the screen to the additional new screen brightness setting, an indication of the remaining battery life currently available based on the additional new screen brightness setting.

20. A method implemented in a computing device, the method comprising:
displaying a scale of possible screen brightness settings for a screen of the computing device, including displaying an icon at a location on the scale indicating a current screen brightness setting;
displaying, in one or both of hours and minutes, an indication of a remaining battery life currently available based on the current screen brightness setting;
receiving a user input to change the screen brightness to a new screen brightness setting;
displaying, in response to the user input, the scale indicating the new screen brightness setting for the screen rather than the current screen brightness setting for the screen, including displaying the icon at a location on the scale indicating the new screen brightness setting;
identifying, in response to the user input, the remaining battery life currently available based on the new screen brightness setting;
changing, in response to the user input, the screen to the new screen brightness setting; and
displaying, in response to the user input and concurrently with changing the screen to the new screen brightness setting, an indication of the remaining battery life currently available based on the new screen brightness setting, the indication of the remaining battery life currently available based on the new screen brightness setting being in one or both of hours and minutes.
